(19) United States
(12) Patent Application Publication
(10) Pub. No.: US 2012/0321523 A1
(43) Pub. Date: Dec. 20, 2012

(54) EXHAUST EMISSION CONTROL DEVICE

(75) Inventor: Masatoshi Shimoda, Hino-shi (JP)

(73) Assignee: HINO MOTORS, LTD., Tokyo (JP)

(21) Appl. No.: 13/581,570

(22) PCT Filed: Mar. 9, 2011
(86) PCT No.: PCT/JP2011/001376

§ 371 Date: Aug. 28, 2012

(30) Foreign Application Priority Data
Mar. 11, 2010 (JP) 2010-054181

(51) Int. Cl. F02M 27/04; B01D 53/94

(52) U.S. Cl. 422/168; 422/186.04

(57) ABSTRACT

An exhaust emission control device for a diesel engine 1, in which fuel is injected prior to a compression upper dead center and is ignited and burned after accelerated premixing of the fuel, is provided with a plasma fuel reformer 17 which produces H₂-containing reformed gas through plasma discharge using the fuel F as a starting material and supplies the reformed gas through an intake manifold 6 into cylinders 7.

### TECHNICAL FIELD

The present invention relates to an exhaust emission control device.

### BACKGROUND ART

Nowadays under review is employment of premixed combustion to a diesel engine for an automobile which injects fuel not at or near but prior to a compression upper dead center to ignite and burn the fuel after accelerated premixing of the fuel through pre-charge of the same to cylinders, thereby suppressing generation of black smoke.

In order to prevent premature ignition in the employment of the premixed combustion to the diesel engine, exhaust gas recirculation (EGR) must be used in combination which returns part of exhaust gas from an engine exhaust passage to an engine intake passage to suppress combustion of the fuel and thus lower temperatures in the cylinders; however, increase in charged amount of the exhaust gas into the cylinders may cause lack of O₂ and thus combustion instability so that misfire is liable to occur with unburned HC and CO remaining.

Particularly, in an engine middle or high load region with an injected amount of fuel being increased, the fuel premixed up to the ignition is burned all at once and thus fast and furious combustion is liable to occur; however, since the increase in charged amount (EGR amount) of the exhaust gas to the cylinders may cause misfire as mentioned in the above, studies and researches have been developed, up to the present, on the employment of the premixed combustion only to a low load region.

Thus, it is conceivable to supply H₂, which is highly combustible even if it is lean, to the cylinders for prevention of misfire due to lack of O₂ and for reduction of unburned HC and CO; already proposed is use of a catalytic fuel reformer which reforms diesel-engine fuel (light diesel oil) through a catalyst to produce H₂-containing reformed gas, the reformed gas being fed through an intake pipe to cylinders (see, for example, Patent Literature 1).

### CITATION LIST

### Patent Literature

[Patent Literature 1] JP 2009-216041A

### SUMMARY OF INVENTION

### Technical Problems

In the catalytic fuel reformer which catalytically reforms the fuel to produce the H₂-containing gas, no reaction occurs unless an ambient temperature of the catalyst is kept of the order of 600° C. To this end, part of the diesel-engine fuel is appropriated for temperature elevation of the catalyst, which fact is disadvantageous from the viewpoint of fuel consumption.

Further, the H₂-containing reformed gas is unavailable until an ambient temperature of the catalyst comes to the above-mentioned value; premixed combustion cannot be conducted just after start-up of the engine in a stable combustion condition.

The invention was made in view of the above and has its object to provide an exhaust emission control device which is well in fuel consumption rate and can conduct premixed combustion just after start-up of the engine in a stable condition.

### Solution to Problems

In order to attain the above object, the invention is directed to an exhaust emission control device, wherein fuel injection is conducted prior to a compression upper dead center at least at low load operation, is ignited and burned after accelerated premixing of the fuel, part of exhaust gas being returned from an engine exhaust passage to an engine intake passage, comprising a plasma fuel reformer for producing H₂-containing reformed gas through plasma discharge using the engine fuel as a starting material to supply said reformed gas to the engine intake passage.

The exhaust emission control device may further comprise a NOₓ storage reduction catalyst incorporated in said engine exhaust passage and a nozzle upstream of said NOₓ storage reduction catalyst,

H₂- and CO-containing reformed gas being produced in said plasma fuel reformer using the engine fuel as a starting material and being supplied to said nozzle and said engine intake passage.

### Advantageous Effects of Invention

An exhaust emission control device of the invention can exhibit the following excellent effects.

(1) The fuel consumption rate is enhanced since a plasma fuel reformer as reformed-gas producing means does not appropriate the engine fuel for temperature elevation of the catalyst unlike a catalytic fuel reformer which catalytically reforms the fuel.

(2) Premixed combustion can be conducted just after start-up of the engine in a stable combustion state since plasma discharge generated brings about H₂-containing reformed gas.

(3) H₂- and CO-containing reformed gas supplied through the nozzle and upstream of the NOₓ storage reduction catalyst in a direction of flow of the exhaust gas can reduce NOₓ from the NOₓ storage reduction catalyst into desorption of N₂, CO₂ and H₂O.

### BRIEF DESCRIPTION OF DRAWINGS

FIG. 1 is a schematic diagram showing an embodiment of an exhaust emission control device according to the invention; and

FIG. 2 is a sectional view showing an embodiment of a plasma fuel reformer in connection with FIG. 1.

### DESCRIPTION OF EMBODIMENT

An embodiment of the invention will be described with reference to the drawings.

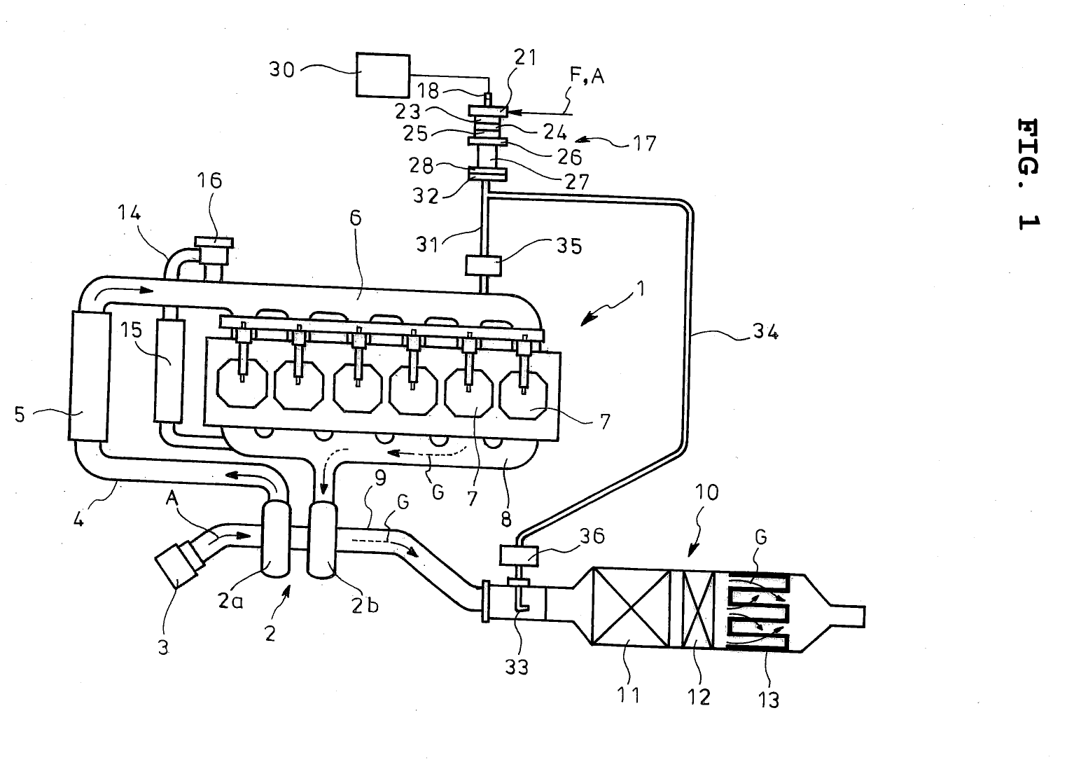

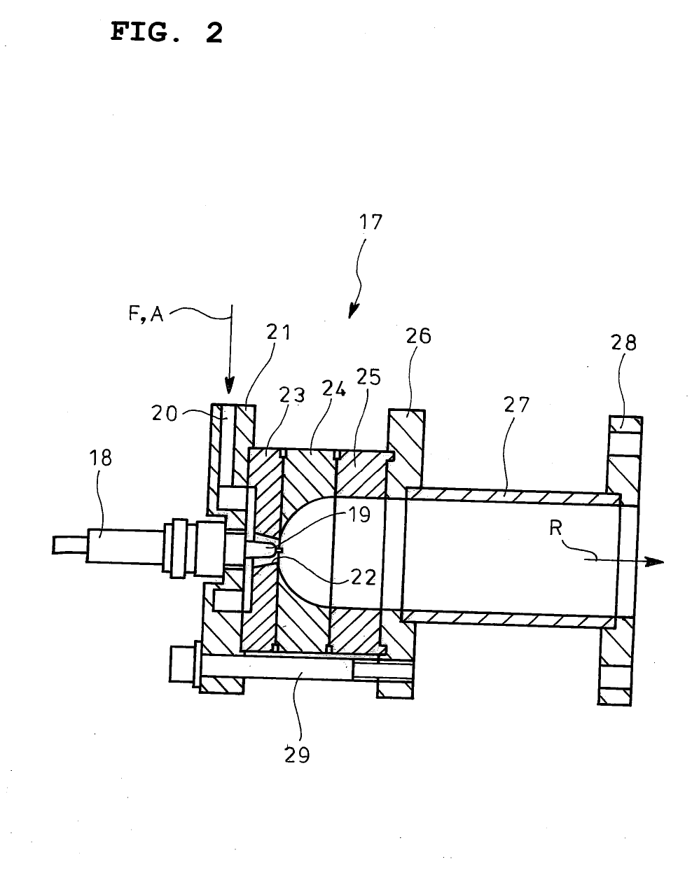

FIGS. 1 and 2 show the embodiment of the exhaust emission control device according to the invention in which reference numeral 1 denotes an diesel engine with a turbocharger 2. Intake air A introduced through an air cleaner 3 is fed through an intake pipe 4 to a compressor 2a of a turbocharger 2. The intake air A pressurized by the compressor 2a is cooled by an intercooler 5 and is fed to an intake manifold 6 where it is distributed to respective cylinders 7 of the diesel engine 1.

Exhaust gas G discharged through the respective cylinders 7 of the diesel engine 1 is fed through an exhaust manifold 8 to a turbine 2b of the turbocharger 2. The exhaust gas G having driven the turbine 2b is discharged outside of the vehicle through an exhaust pipe 9 and an aftertreatment device 10.

The aftertreatment device 10 is constituted by incorporating, in a single casing, a NOₓ storage reduction catalyst 11, an oxidation catalyst 12 and a particulate filter 13 in the order named from upstream to downstream in a direction of flow of the exhaust gas G.

The NOₓ storage reduction catalyst 11 produces NO₂ from NOₓ and O₂ contained in the exhaust gas G through catalyst Pt, and retains nitrate salt BaNO₂ resulting from a reaction of NO₂ with Ba or other absorbing agent.

The oxidation catalyst 12 oxidizes HC and a resultant reaction heat elevates in temperature the exhaust gas G. Soot captured by the particulate filter 13 is burned by heat of the exhaust gas G.

Arranged between the exhaust manifold 8 and a portion of the intake pipe 4 downstream of the intercooler 5 is an EGR conduit 14 which returns the exhaust gas G to the cylinders 7. Incorporated in the EGR conduit 14 are an EGR cooler 15 and an EGR valve 16 in the order named from upstream to downstream in the direction of flow of the exhaust gas G.

The invention is characteristic in provision of a plasma fuel reformer 17 which produces H₂-containing reformed gas R through plasma discharge using the fuel (light diesel oil) F as a starting material.

The plasma fuel reformer 17 comprises an end plate 21 with a high-voltage plug 18 centrally screwed into the plate from one surface toward the other surface thereof and with a passage 20 extending through the plate for feed of the fuel F and intake air A from outside to a perimeter of an electrode 19 of the high-voltage plug 18, a first annular member 23 with an opening 22 circumferentially surrounding the electrode 19 and abutting at its one surface on the other surface of the end plate 21, a second annular member 24 abutting at its one surface on the other surface of the first annular member 23, a third annular member 25 abutting at its one surface on the other surface of the second annular member 24, a flange 26 abutting at its one surface on the other surface of the third annular member 25, a short pipe 27 with one end fixed through welding to the flange 26 and a flange 28 fixed through welding to the other end of the short pipe 27. With a bolt 29 for fixture of the flange 26 to the end plate 21, the end plate 21, the first, second and third annular members 23, 24 and 25 and the flange 26 are bound integrally.

For example, the fuel F distributed through a regulator from a fuel conduit between a fuel feed pump and a common rail as components in a common rail type fuel injection device and the intake air A from a discharge side of the compressor 2a in the turbocharger 2 are mixed together in a mixer and then is fed to the passage 20. As fuel feed means to the passage 2, a dedicated pump may be provided; alternatively, air from an air brake device may be distributed into the passage 20 through a regulator.

An inner periphery of the second annular member 24 is formed with a concave which is smoothly contiguous from an inner cylindrical periphery of the third annular member 25 to the opening 22 of the first annular member 23. The first annular member 23 is made of ceramic. The second and third annular members 24 and 25 are made of metal and ceramic, respectively, or vice versa. Application of high voltage from the power source 30 to the high-voltage plug 18 causes plasma discharge between the electrode 19 and the metallic second annular member 24, or between the electrode 19 and the metallic third annular member 25. Flow of the fuel F and air (intake air A) there at or above stoichiometric mixture ratio produces H₂, CO and the like.

Connected to the flange 28 of the plasma fuel reformer 17 through a flange 32 is a gas conduit 31 which communicates with an interior of the intake manifold 6 in the diesel engine 1. Arranged in the aftertreatment device 10 upstream of the NO storage reduction catalyst 11 in the direction of flow of the exhaust gas G is a reformed-gas adding nozzle 33 to which connected is a gas conduit 34 branched from the gas conduit 31. Incorporated in the gas conduits 31 and 34 are addition valves 35 and 36, respectively.

In the diesel engine 1, in order to prevent premature ignition in employment of the premixed combustion through the fuel injection prior to the compression upper dead center, exhaust gas recirculation is used in combination which returns part of the exhaust gas G from the exhaust manifold 8 through the EGR conduit 14 to the intake manifold 6 to suppress combustion of the fuel in the cylinders 7 through the exhaust gas G and thus lower temperatures in the cylinders 7.

The addition valve 35 is opened, a mixture of the fuel F and the intake air is fed into the plasma fuel reformer 17 and high voltage is applied to the high-voltage plug 18 by the power source 30. As a result, plasma discharge occurs in the plasma fuel reformer 17 to reform the fuel F into the H₂-including reformed gas R which in turn is supplied through the gas conduit 31 and the intake manifold 6 into the cylinders 7.

H₂, which is highly combustible even if it is lean, stabilizes the combustion in the cylinders 7, prevents misfire due to lack of O₂ and reduces unburned HC and CO. Thus, in an engine middle or high load region, even if the charge of the exhaust gas into the cylinders 7 is increased, no misfire is caused, the combustion is stabilized, the combustion time is shortened, and improvement in the fuel consumption rate can be expected. In the reformed gas R, not only H₂ but also HC and CO are included, these HC and CO being burned together with H₂.

Feed rate of the H₂ is adjusted depending on an operation condition of the diesel engine 1.

In comparison with a catalytic fuel reformer which reforms fuel through a catalyst and which is disadvantageous from the viewpoint of fuel consumption since the fuel F is appropriated for temperature elevation of the catalyst, the plasma fuel reformer 17 has energy consumption which is expected as low as a several hundred-watt. Moreover, because of H₂-containing reformed gas R being obtained by application of high voltage to the high-voltage plug 18, the premixed combustion can be conducted just after start-up of the engine in a stable combustion condition.

When NOₓ retained in the NOₓ storage reduction catalyst 11 is to be removed, the addition valve 36 is opened, the reformed gas R produced in the plasma fuel reformer 17 is fed through the nozzle 33 and upstream of the NOₓ storage reduction catalyst 11 in the direction of flow of the exhaust gas G. As a result, H₂ and CO contained in the reformed gas R reduce the NOₓ into desorption of N₂, CO₂ and H₂O with BaNO₂ being returned into Ba.

The reformed gas R is fed as rich spike depending on the condition of the NOₓ storage reduction catalyst 11.

Downstream of the plasma fuel reformer 17, a reforming catalyst may be provided so as to improve production efficiency of H₂.

It is to be understood that an exhaust emission control device according to the invention is not limited to the above-mentioned embodiment and that various changes and modifications may be made without departing from the scope of the invention.

### REFERENCE SIGNS LIST

1 diesel engine

6 intake manifold (engine intake passage)

10 NOₓ storage reduction catalyst

17 plasma fuel reformer

33 nozzle

F fuel

G exhaust gas

R reformed gas

1. An exhaust emission control device, wherein fuel injection is conducted prior to a compression upper dead center at least at low load operation, is ignited and burned after accelerated premixing of the fuel, part of exhaust gas being returned from an engine exhaust passage to an engine intake passage,
comprising a plasma fuel reformer for producing H₂-containing reformed gas through plasma discharge using the engine fuel as a starting material to supply said reformed gas to the engine intake passage.

2. The exhaust emission control device as claimed in claim 1 further comprising a NOₓ storage reduction catalyst incorporated in said engine exhaust passage and a nozzle upstream of said NOₓ storage reduction catalyst,
H₂- and CO-containing reformed gas being produced in said plasma fuel reformer using the engine fuel as a starting material and being supplied to said nozzle and said engine intake passage.
